(19) United States
(12) Patent Application Publication
(10) Pub. No.: US 2020/0166027 A1
(43) Pub. Date: May 28, 2020

(54) PRESSURE INTENSIFIER, ARRANGEMENT IN AN AIRCRAFT OR SPACECRAFT COMPRISING A DEVICE DRIVEABLE BY A DRIVING PRESSURE DIFFERENCE, AIRCRAFT OR SPACECRAFT, AND METHOD

(71) Applicant: AIRBUS OPERATIONS GMBH, Hamburg (DE)

(72) Inventors: Wilhelm LUTZER, Hamburg (DE); Holger CZOPKA, Hamburg (DE)

(21) Appl. No.: 16/690,204

(22) Filed: Nov. 21, 2019

(30) Foreign Application Priority Data
Nov. 22, 2018 (DE) 10 2018 220 055.6

(51) Int. Cl. F04B 37/14; B64D 11/06

(52) U.S. Cl. CPC F04B 37/14; A47K 11/02; B64D 11/0639

(57) ABSTRACT

A pressure intensifier, arrangement in an aircraft or spacecraft including a device driveable by a driving pressure difference, aircraft or spacecraft, and method. A pressure intensifier has a motor part with motor-part-side fluid inlet and motor-part-side fluid outlet and a pump part with pump-part-side fluid inlet and pump-part-side fluid outlet. The pressure intensifier, as a positive-displacement machine with at least one rotatable rotor, is driveable by a motor-part-side fluid flow from the motor-part-side fluid inlet to the motor-part-side fluid outlet for conveying pump-part-side fluid flow from the pump-part-side fluid inlet to the pump-part-side fluid outlet. An arrangement in an aircraft or spacecraft includes a device driveable by a driving pressure difference and includes a vacuum booster. An aircraft or spacecraft has a pressure intensifier of the type and/or an arrangement of the type, and a method is disclosed for operating a device in an aircraft or spacecraft.

### CROSS-REFERENCE TO RELATED APPLICATION

This application claims priority to Application No. DE 10 2018 220 055.6 filed Nov. 22, 2018, the entire disclosure of which is incorporated by reference herein.

### TECHNICAL FIELD

The disclosure herein relates to a pressure intensifier, in particular a vacuum booster. The disclosure herein furthermore relates to an arrangement in an aircraft or spacecraft comprising a device driveable by a driving pressure difference. The disclosure herein furthermore relates to an aircraft or spacecraft having a pressure intensifier of the type and/or having an arrangement of the type, and to a method for operating a device in an aircraft or spacecraft.

Although the disclosure herein may be expedient and useful in a wide variety of technical fields in which pressure intensification and in particular the expedient provision of a pressure difference is desired, it is the intention below to describe the disclosure herein, and the problem on which it is based, in terms of the example of the compaction of waste in an aircraft by negative pressure.

### BACKGROUND

In passenger aircraft, a certain amount of waste is commonly accumulated during the journey. The waste items accumulated may comprise in particular packaging materials for meals or beverages and the like, including for example packagings composed of plastic, paper or cardboard, cups, bags, etc., which may also include residues of the packaged products. In the initial state, such waste takes up a large volume and requires a lot of space for storage.

For expedient space-saving storage of the waste items, these can be compacted. EP 2 949 459 A1 and US 2015/0343732 A1, for example, describe a system for compacting waste in an aircraft by a vacuum. Further systems for waste compaction, for example in an aircraft, are described for example in DE 10 2016 108 362 A1.

Furthermore, pressure intensifiers designed as piston appliances are known per se. The principle of such pressure intensifiers is based on a large piston being connected to a relatively small piston. In this way, the pressure intensifier, driven by a large volume flow with a small pressure difference, can provide a relatively small volume flow with a greater pressure difference. In order that the process does not end at a dead center after a working stroke, a second, identically designed unit is provided which, during its subsequent working stroke, moves the former unit back into the initial position. In the case of such pressure intensifiers, a control device is necessary in order to be able to perform the individual working strokes in succession in the form of a continuous process.

Such pressure intensifiers based on the piston principle can generate intense vibrations in the case of a high throughput, and operate only with a single pressure ratio that is defined in advance by the design. Furthermore, such piston units require a considerable amount of space and have a considerable weight.

Furthermore, rotating positive-displacement pumps, that is to say positive-displacement pumps with a stator and a rotatable rotor, for example vane-type pumps or rotary slide pumps, are known per se. As structural types, a distinction is made for example between balanced or imbalanced vane-type pumps, wherein, in the case of balanced vane-type pumps, multiple inlets and outlets may be provided in order to realize compensation of the reaction forces that act on the rotor of the vane-type pump.

### SUMMARY

Against this background, it is an object of the disclosure herein to permit the operation of a device driveable by a pressure difference, for example a compacting device for waste items, in a space-saving and weight-saving and reliable manner with a low level of vibrations, even if a pressure difference available for the operation and provided for example by a vacuum or negative-pressure system already provided for other purposes is in some situations not sufficient or a greater pressure difference appears desirable.

According to the subject matter herein, the object is achieved by a pressure intensifier and/or an arrangement and/or an aircraft or spacecraft and/or a method having features disclosed herein.

Accordingly, a pressure intensifier is proposed which is designed in particular as a vacuum booster. The pressure intensifier has a motor part with a motor-part-side fluid inlet and a motor-part-side fluid outlet and has a pump part with a pump-part-side fluid inlet and a pump-part-side fluid outlet. The pressure intensifier is driveable by a motor-part-side fluid flow from the motor-part-side fluid inlet to the motor-part-side fluid outlet for the purposes of conveying a pump-part-side fluid flow from the pump-part-side fluid inlet to the pump-part-side fluid outlet. According to the disclosure herein, the pressure intensifier is designed as a positive-displacement machine with at least one rotatable rotor.

Also proposed is an arrangement in an aircraft or spacecraft which comprises a device driveable by a driving pressure difference. Furthermore, the arrangement comprises a vacuum booster for providing the driving pressure difference utilizing an input pressure difference which is smaller than the provided driving pressure difference.

Also provided is an aircraft or spacecraft, in particular an airplane, having a pressure intensifier according to the disclosure herein and/or having an arrangement according to the disclosure herein.

Also proposed according to the disclosure herein is a method for operating a device in an aircraft or spacecraft, wherein the method comprises:
discharging a first fluid flow as air volume flow from an interior space of a pressurized cabin of the aircraft or spacecraft via a motor part of a vacuum booster in the direction of external surroundings of the aircraft or spacecraft;
driving the vacuum booster by the first fluid flow and, by the vacuum booster driven in this way, providing a second fluid flow as air volume flow at a pump part of the vacuum booster, wherein the second fluid flow is discharged in the direction of the external surroundings of the aircraft or spacecraft; and
operating the device by the discharge of the second fluid flow.

A concept on which the disclosure herein is based consists in that, by a rotating positive-displacement machine, that is to say a positive-displacement machine with a rotatable rotor, a pressure intensification is made possible in continuous operation, without a control unit being required for this purpose. Such a pressure intensifier or pressure transformer thus has a simple construction, which is also beneficial for the reliability of the pressure intensifier and of a system equipped therewith. The maintenance and inspection requirements can advantageously likewise be reduced. Furthermore, a pressure intensifier of the type can be of lightweight and small construction. Also, for pressure intensification or transformation in the case of relatively small volume flows and relatively low flow speeds, positive-displacement machines operate in an effective and efficient manner.

A further realization on which the disclosure herein is based consists in that, with the use of an input pressure difference, which is based for example on an existing vacuum or negative pressure for example in the external surroundings of an aircraft or spacecraft, for driving a device, a desired or required driving pressure difference can be provided in an expedient, simple and reliable manner even if the conditions in the external surroundings vary by virtue of a vacuum booster being provided which provides the driving pressure difference utilizing the input pressure difference. Using the vacuum booster, it is advantageously the case that no additional motor-type drive devices for a vacuum pump or the like are required in order to ensure an adequate pressure difference. Instead, an existing pressure difference, for example between a pressurized cabin and external surroundings, can be utilized for driving the vacuum booster. In this regard, it is thus the case with the disclosure herein that a vacuum booster is provided which, similarly to a turbocharger, requires no additional motor-type drive devices.

The disclosure herein thus advantageously makes it possible in particular to ensure reliable operation of a device, for example for compacting waste by negative pressure, in a simple and reliable manner even when an aircraft or spacecraft is at relatively low altitudes with correspondingly relatively high air pressure in the external surroundings thereof, for example during a landing approach.

Advantageous embodiments and refinements will emerge from the disclosure herein with reference to the figures.

In one embodiment, the motor part and the pump part are designed such that a first volume flow corresponding to the motor-part-side fluid flow is greater than a second volume flow corresponding to the pump-part-side fluid flow. In this way, it is possible with the aid of a large volume flow with a relatively small pressure difference to provide a greater pressure difference in discharging a smaller volume flow.

The volume flow ratio may advantageously be selected for example such that the motor-part-side volume flow corresponds to two to three times the pump-part-side volume flow. Such a volume flow ratio may be expedient for example in the case of the pressure intensifier being utilized as a vacuum booster for example for the operation of a waste-compacting device in an aircraft or spacecraft, for example an airplane.

In one refinement of the disclosure herein, the pressure intensifier is designed in accordance with the principle of a vane-type machine.

In one embodiment, the at least one rotor has displaceably arranged vanes. In particular, here, the motor part is operable in the manner of a vane-type motor and the pump part is operable in the manner of a vane-type pump. Such an embodiment permits a relatively uniform conveying action on the pump side together with a simple, inexpensive construction with simultaneous reduction of vibration and noise generation. The motor part may thus be regarded in particular as a compressed-air-operated motor, for example as a vane-type motor, which drives a compressed-air pump, for example a vane-type pump.

In a preferred embodiment, the rotor of the pressure intensifier is designed as a rotor common to the motor part and the pump part, wherein the common rotor, during operation, comes into contact in certain portions with the motor-part-side fluid flow and the pump-part-side fluid flow. In this way, the construction of the pressure intensifier can be yet further simplified. In particular, the pressure intensifier can be formed with a single rotor. Through the use of a common rotor for motor and pump part, the variety of components is further reduced, which in turn can have an expedient effect on the production outlay and the reliability of the pressure intensifier. In particular, the number of rotating components can advantageously be reduced in that, in this embodiment, motor-part-side and pump-part-side fluid flows act on the same rotor. Furthermore, with this embodiment, the structural space required for the pressure intensifier can also be yet further reduced.

In one embodiment, the motor part and the pump part together form a structural unit. Here, a housing is provided which is common to the motor part and the pump part, wherein the housing has the motor-part-side fluid inlet, the motor-part-side fluid outlet, the pump-part-side fluid inlet and the pump-part-side fluid outlet, such that the motor-part-side fluid inlet, the motor-part-side fluid outlet, the pump-part-side fluid inlet and the pump-part-side fluid outlet each have a fluid-conducting connection to an interior region of the housing defined by an internal contour of same. This embodiment contributes in turn to a compact and simple construction of the pressure intensifier. In particular, here, the common rotor may be accommodated in the interior region of the housing, wherein the housing forms a stator of the positive-displacement machine.

In one embodiment, a position of an axis of rotation of the rotor relative to the housing is adjustable. This advantageously permits adjustability of the ratios of the motor-part-side and pump-part-side volume flows and pressure differences. The pressure intensifier can thus, for example, with regard to its function, be even better adapted to the device to be driven, or pressure intensifiers of the same type of construction can be utilized for different devices to be driven.

In one refinement, the position of the axis of rotation may be displaceable, for example displaceable approximately in the direction of the greatest extent of the interior region of the housing. An adjustment of the pressure ratio between motor part and pump part is thus made possible in a simple manner.

In one embodiment, the pressure intensifier is configured for being driven by a pressure difference between the interior pressure in a pressurized cabin of an aircraft or spacecraft and an external pressure in external surroundings of the aircraft or spacecraft. The pressure difference that exists in any case between the air pressure in the interior of the pressurized cabin and the air pressure in the external surroundings can thus be utilized for driving the pump part of the pressure intensifier, wherein the motor-part-side fluid flow is driven by the pressure difference between the interior of the pressurized cabin and the external surroundings. There is therefore no need for additional motor devices for the pressure transformation.

In particular, here, the motor part may be driven by the pressure difference between the cabin interior pressure and the external ambient pressure, while air is extracted from the device to be driven, in particular for example the waste-compacting device, by the pump part driven by the motor part.

The pressure intensifier is, as a vacuum booster, designed in particular for generating, on the pump part side, a pressure difference which is greater than a motor-part-side input pressure difference, in particular between an interior air pressure in a pressurized cabin of an aircraft or spacecraft and an air pressure in external surroundings of the aircraft or spacecraft. The pump-part-side pressure difference can then be utilized as driving pressure difference for the device to be driven.

In one embodiment of the arrangement, the vacuum booster is designed as a rotating positive-displacement machine, in particular as a pressure intensifier designed according to the disclosure herein. The advantages achievable with this have already been mentioned above.

In one embodiment of the arrangement, the device is couplable in fluid-conducting fashion via a first line path to a negative-pressure source, an interior space of a pressurized cabin of the aircraft or spacecraft is couplable in fluid-conducting fashion to the negative-pressure source via a second line path, and the vacuum booster is arranged such that the first line path leads via a pump part of the vacuum booster and the second line path leads via a motor part of the vacuum booster. A volume flow that can be effected via the second line path by the air pressure difference between the interior space of the pressurized cabin and the external surroundings can thus be utilized for boosting the pressure difference in the extraction of a volume flow via the first line path. Again, there is no need for additional motor devices for driving the vacuum booster.

In one embodiment of the arrangement, the first and second line path can be placed in fluidic connection with a drain mast of a wastewater system of the aircraft or spacecraft or with a line of a vacuum toilet system of the aircraft or spacecraft as negative-pressure source. Thus, a negative-pressure source that is already present in the aircraft or spacecraft, which is for example a passenger airplane, can be jointly utilized for operating the device. A drain mast or a line of a vacuum toilet system can provide substantially the external ambient pressure as negative pressure.

A drain mast may refer to a pipe-like structure, for example of streamlined form on the outside, which projects out of the fuselage of an aircraft or spacecraft and in particular of an airplane and via which, for example, wastewater of a hand washbasin or of an on-board kitchen can be discharged. The drain mast thus has a connection to the external surroundings and thus to the external air pressure, which is lower in relation to the cabin interior pressure.

In one embodiment of the arrangement, the device that can be driven by the driving pressure difference is designed as a waste-compacting device. A compaction of accumulated waste items can thus be realized in a robust and effective manner.

In a further embodiment of the arrangement, the device that can be driven by the driving pressure difference may be designed as an adjusting device for a component of a seat arrangement.

In one embodiment, the pressure intensifier is formed with a plastics material or multiple plastics materials. In particular, the housing or housings and/or the rotor or rotors and/or the vanes may be manufactured with one or more plastics materials. In this way, a low weight of the pressure intensifier is advantageously made possible, which is advantageous for example in applications in the aerospace sector. In particular in the case of the pressure intensifier being used as a vacuum booster for boosting the negative pressure for the operation of a device for example in an aircraft, the stated weight reduction through the utilization of plastics materials is possible because no extreme temperatures are to be expected.

The above-described embodiments and refinements can each be analogously applied to the pressure intensifier, the arrangement, the aircraft or spacecraft and the method according to the disclosure herein.

The above embodiments and refinements may be combined with one another as desired where expedient. Further possible embodiments, refinements and implementations of the disclosure herein also encompass combinations, which are not explicitly mentioned, of features of the disclosure herein described above or below with regard to the example embodiments. In particular, a person skilled in the art will also add individual aspects as improvements or additions to the respective basic form of the disclosure herein.

### BRIEF DESCRIPTION OF THE DRAWINGS

The disclosure herein will be discussed in more detail below on the basis of the example embodiments shown in the schematic figures. In the figures:

FIG. 1 shows a perspective view of an airplane in which the disclosure herein can, according to example embodiments, be used;

FIGS. 2A and 2B are schematic illustrations for explaining the functioning of a waste-compacting device operated by a pressure difference;

FIG. 3 is a schematic illustration for explaining a connection of the waste-compacting device to a main line of a vacuum toilet system;

FIG. 4 is a schematic illustration for explaining a connection of the waste-compacting device to a drain mast;

FIG. 5 is a schematic illustration of a pressure intensifier according to a first example embodiment;

FIG. 6 is a schematic illustration of a pressure intensifier according to a second example embodiment;

FIG. 7 is a schematic illustration of an arrangement in an airplane, having a pressure intensifier, according to an example embodiment;

FIG. 8 is a schematic illustration of an arrangement in an airplane, having a pressure intensifier, according to a further example embodiment; and

FIG. 9 is a schematic illustration of a seat arrangement, for example for an airplane passenger, having an adjusting device operated by a pressure difference, according to a further example embodiment.

The appended figures are intended to provide improved understanding of the embodiments of the disclosure herein. They illustrate embodiments and serve, in conjunction with the description, for the explanation of principles and concepts of the disclosure herein. Other embodiments, and many of the stated advantages, will emerge with regard to the drawings. The elements of the drawings are not necessarily shown true to scale relative to one another.

In the figures of the drawing, elements, features and components which are identical, functionally identical and of identical action are denoted in each case by the same reference designations unless stated otherwise.

### DETAILED DESCRIPTION

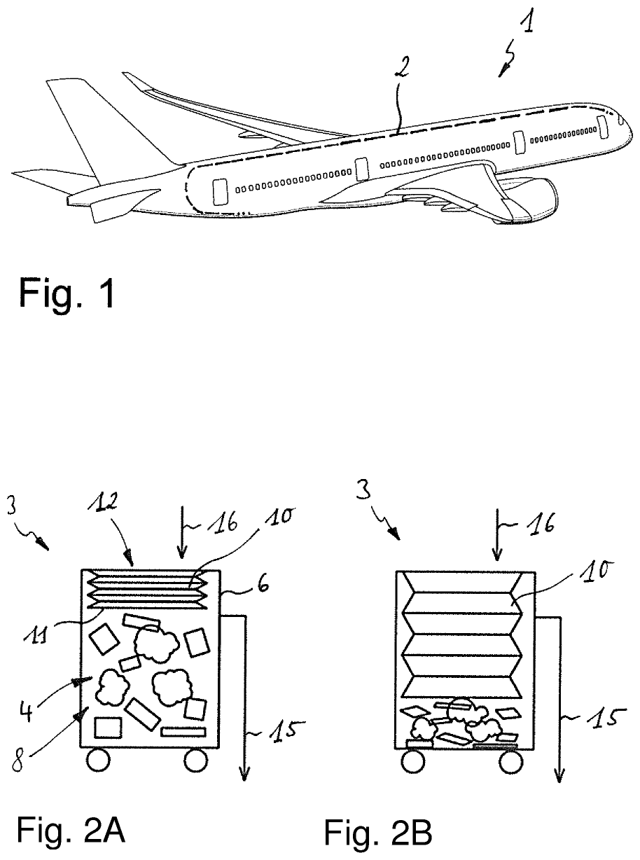

FIG. 1 shows an airplane 1 with a schematically indicated pressurized cabin 2, in the illustrated example a passenger airplane, in flight. Outside the airplane 1, an external air pressure prevails which decreases with increasing altitude. Between the cabin interior pressure, which in modern passenger airplanes is kept in a range compatible with the well-being of passengers and crew, and the static pressure of the external atmosphere, there is therefore a pressure difference, which may for example amount to up to approximately 650 mbar at normal cruising altitude.

In passenger airplanes, meals and/or beverages are often served, wherein waste items such as packagings, cups, serviettes, etc. may accumulate. For the space-saving storage of these and other possible waste items accumulated during a journey for later disposal, a waste-compacting device 3 is provided in the passenger cabin of the airplane 1, by which waste-compacting device the volume of the waste items can be reduced.

FIGS. 2A and 2B schematically depict the functioning of the waste-compacting device 3. FIG. 2A shows waste items 4 which have not yet been compacted and which are collected in a waste-receiving region in the interior space 8 of a mobile trolley 6. Above the waste items 4, there is provided a compacting mechanism, which has for example a corrugated bellows 10 with a solid compacting plate 11 arranged on the bottom side of the corrugated bellows. Via an open top side 12 of the corrugated bellows 10 or some other fluid-conducting connection between an interior region of the corrugated bellows 10 and the interior space of the passenger cabin 2, the interior region of the corrugated bellows 10 is charged with the cabin internal pressure, that is to say the air pressure in the interior of the pressurized cabin 2. The interior space 8 of the trolley 6, which is sealed off with respect to the interior of the corrugated bellows 10, can be connected by a line 15 to a negative-pressure source (not shown in FIG. 2), for example by the opening of a valve or of multiple valves.

In FIG. 2B, it is shown that the corrugated bellows 10 expands when the interior space 8 is connected to the negative-pressure source while the interior region of the corrugated bellows 10 is charged with the cabin interior air pressure.

The waste-compacting device 3 operated by negative pressure can also be referred to as “vacuum trash compactor”. Furthermore, the abovementioned negative-pressure source may also be referred to as vacuum source, wherein, in the present case, the expression “vacuum” is to be understood in the broader sense of a low pressure or negative pressure such as prevails for example in the external surroundings of the airplane 1, for example at normal cruising altitude.

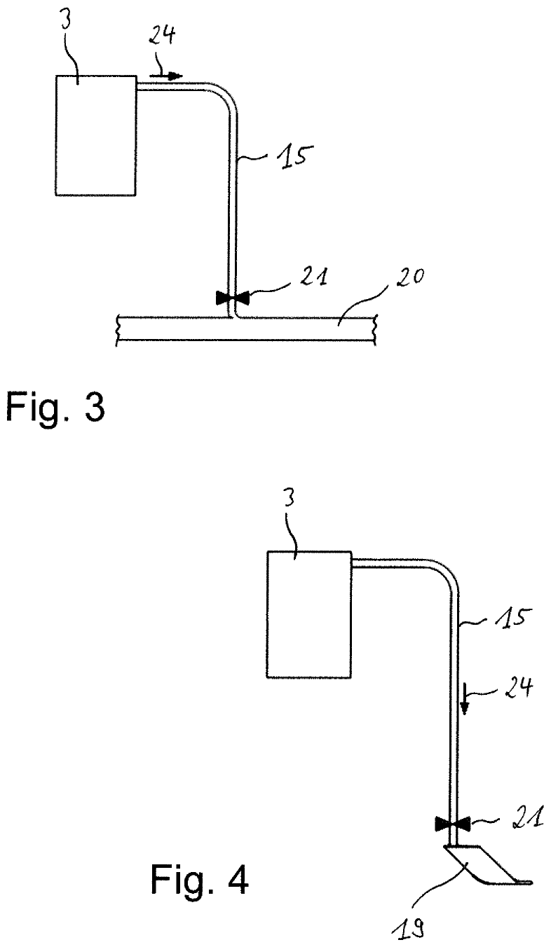

For example, a vacuum toilet system of the airplane 1 with a main line 20, or a wastewater system of the airplane 1 with a so-called drain mast 19, may serve as negative-pressure source for the operation of the waste-compacting device 3. These are shown by way of example in FIGS. 3 and 4 respectively. The wastewater system or the toilet system respectively is connected to the external surroundings of the airplane 1 via the drain mast 19 of the wastewater system or the main line 20 of the vacuum toilet system. In this way, both the wastewater system and the vacuum toilet system as vacuum source for the waste-compacting device 3 provide substantially the same negative pressure. FIGS. 3 and 4 each also illustrate a valve 21 in the line 15, by which valve the connection to the main line 20 or to the drain mast 19 can be selectively produced or shut off. During the operation of the waste-compacting device 3, an air volume flow 24 can be discharged via the line 15. It is self-evident that, in one variant, the waste-compacting device 3 could be assigned a connection to the external surroundings provided specifically for this purpose, without the path via the wastewater or toilet system.

FIGS. 3 and 4 show possibilities of how the waste-compacting device 3 can be operated in particular at cruising altitude. The compaction of the waste items 4 in FIG. 2B is thus effected by the pressure difference between the cabin interior air pressure and the static ambient air pressure outside the airplane 1, and the waste-compacting device 3 is consequently driven by the pressure difference. The cabin interior pressure prevailing in the interior of the corrugated bellows 10 is schematically indicated by the arrow 16.

In order to effect a good, effective compaction of the waste items 4 even at considerably lower altitudes than the normal cruising altitude and thus in the presence of a smaller pressure difference between the cabin interior and the external surroundings, a pressure intensifier 28 or 128 is provided in example embodiments of the disclosure herein. The pressure intensifier 28, 128 described in more detail below, which operates as a vacuum booster, makes it possible to provide a boosted negative pressure, or in other words an increased pressure difference in relation to the cabin interior pressure, to the waste-compacting device 3 for the operation thereof. The waste-compacting device 3 which is driveable by a driving pressure difference is thus provided with the required or desired driving pressure difference by the vacuum booster 28 or 128 through the utilization of an input pressure difference, which corresponds in particular to the pressure difference between the air pressure in the interior space of the pressurized cabin 2 and the external surroundings, wherein the driving pressure difference is greater than the input pressure difference. Thus, even at low altitudes, a vacuum sufficient for reliable operation of the waste-compacting device 3 can be provided, and a satisfactory degree of compaction of the waste 4 can be achieved.

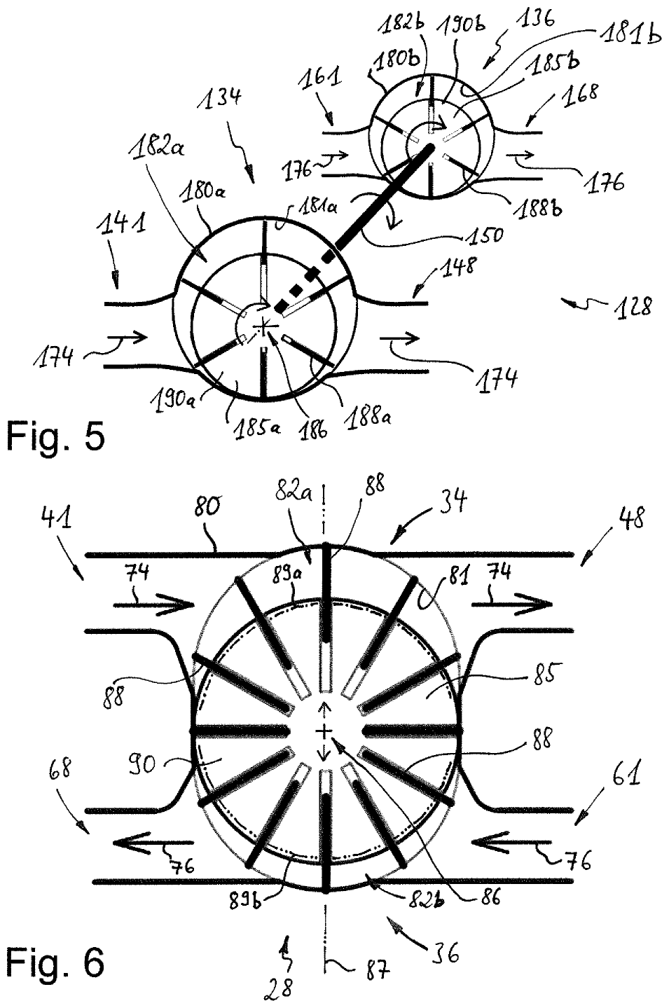

FIG. 5 is a schematic illustration of a pressure intensifier 128 for use as a vacuum booster according to an example embodiment. The pressure intensifier 128 is constructed as a combination of a vane-type motor and a vane-type pump and thus as a rotating positive-displacement machine. Specifically, the pressure intensifier 128 has a motor part 134, which is designed as a vane-type motor, and a pump part 136, which is designed as a vane-type pump.

The motor part 134 has a rotor 185a with an approximately circular cylindrical rotor main body 190a, wherein the rotor main body 190a in the example shown has radially arranged slots and vanes 188a provided in radially displaceable fashion in the slots. The vanes 188a are preferably acted on in an outward direction relative to the rotor main body 190a by spring elements which, for the sake of better clarity, are not shown in any more detail in FIG. 5.

The pump part 136 has a rotor 185b with an approximately circular cylindrical rotor main body 190b. In the example shown, the rotor main body 190b is equipped with radially arranged slots, and the rotor 185b has vanes 188b provided in radially displaceable fashion in the slots. In the case of the pump part 136, too, the vanes 188b are preferably acted on in an outward direction relative to the rotor main body 190b with a spring force by spring elements which are not shown in any more detail.

The rotors 185a, 185b are arranged so as to be rotatable about a common axis of rotation 186 and, for this purpose, are connected by a shaft 150 or are arranged on the common shaft 150. The rotor 185b of the pump part 136 is driven by the rotor 185a of the motor part 134.

The rotor 185a is accommodated in a stator or housing 180a of the motor part 134 and is rotatable in an interior region of the housing 180a, which is defined by an internal contour 181a which is substantially circular in a cross section normal to the axis of rotation 186, such that the vanes 188a make contact with a housing internal wall along the internal contour 181a. The housing 180a is furthermore equipped with a motor-part-side fluid inlet 141 and a motor-part-side fluid outlet 148, which have a fluid-conducting connection to the interior region of the housing 180a. The pressure intensifier 128 is driven by a motor-part-side fluid flow 174, which is in particular an air volume flow, from the fluid inlet 141 to the fluid outlet 148.

The rotor 185b is accommodated in a stator or housing 180b of the pump part 136 and is rotatable in an interior region of the housing 180b, which is defined by an internal contour 181b which is likewise substantially circular in cross section, about the axis 186 such that the vanes 188b make contact with a housing internal wall along the internal contour 181b. The housing 180b is furthermore equipped with a pump-part-side fluid inlet 161 and a pump-part-side fluid outlet 168, which have a fluid-conducting connection to the interior region of the housing 180b. By virtue of the rotor 185b being driven by the rotor 185a via the shaft 150, a pump-part-side fluid flow 176, in particular an air volume flow, is conveyed from the fluid inlet 161 to the fluid outlet 168 of the pump part 136.

The ratio of the volume flow corresponding to the motor-part-side fluid flow 174 to the volume flow corresponding to the pump-part-side fluid flow 176 can be selected through the selection of the size ratio between the motor part 134 and the pump part 136, specifically the size ratios of the rotors 185a,b, of the housings 180a,b and in particular of the cells 182a,b that are formed. In this way, the pressure ratio that can be attained between the pump side and the motor side is also adjusted.

The pressure intensifier 128 of FIG. 5 can, without the imperative need for a control unit, operate in continuous fashion as a vacuum booster and be driven by the pressure difference, which is present in any case, between the pressurized cabin 2 and the external surroundings of the airplane 1. Here, a large volume flow with a pressure difference which, at low altitudes, is relatively small and amounts to for example only approximately 200 mbar or less can drive the vacuum booster as an appliance for generating a small volume flow in order to realize a large pressure difference.

In this case, the motor-part-side volume flow 174 is thus greater than the pump-part-side volume flow 176, wherein the volume flow 174 may correspond to two times to three times the volume flow 176.

In the case of the pressure intensifier 128, therefore, two rotors 185a, 185b are provided which are separate but connected rotationally conjointly to one another and which run in dedicated housings 180a, 180b. It is however pointed out that the two housings 180a, 180b may be connected to one another as a unit or fastened to one another, or that the two housings 180a, 180b may be formed as partial regions of a common housing component. Here, however, separate interior regions for receiving the rotors 185a, 185b are still provided.

A pressure intensifier 28, designed as a vacuum booster, according to a further example embodiment is schematically depicted in FIG. 6 in a cross-sectional illustration. The pressure intensifier 28 also has a motor part 34 with a motor-part-side fluid inlet 41 and a motor-part-side fluid outlet 48 and has a pump part 36 with a pump-part-side fluid inlet 61 and a pump-part-side fluid outlet 68. The pressure intensifier 28 is also designed as a rotating positive-displacement machine and driveable by a motor-part-side fluid flow 74, in particular an air volume flow, from the fluid inlet 41 to the fluid outlet 48 in order to convey a pump-part-side fluid flow 76, again in particular an air volume flow, from the fluid inlet 61 to the fluid outlet 68.

In the case of the pressure intensifier 28 as per FIG. 6, too, an air volume flow corresponding to the motor-part-side fluid flow 74 is greater than an air volume flow corresponding to the pump-part-side fluid flow 76. For example, the volume flow 74 may correspond to two times to three times the volume flow 76.

By contrast to the example of FIG. 5, the pressure intensifier 28 does not have two separately provided rotors for the motor and pump parts, it rather being the case in FIG. 6 that a rotor 85 common to the motor part 34 and the pump part 36 is provided. The motor part 34 and the pump part 36 thus together form a compact, space-saving structural unit which requires few components.

FIG. 6 shows that, in the case of the pressure intensifier 28, the rotor 85 is arranged in a stator or housing 80, wherein the housing 80 is common to the motor part 34 and the pump part 36. The rotor 85 is mounted so as to be rotatable about an axis of rotation 86. An internal contour 81 defines an interior region of the housing 80, in which the rotor 85 is arranged.

In a cross section normal to the axis of rotation 86 of the rotor 85, the internal contour 81, see FIG. 6, is of substantially oval form, that is to say rounded and elongate in relation to a circular cross section. It would for example be possible for the internal contour 81 to terminate with a circular arc shape in the upper and lower regions in FIG. 6, wherein the circular arc shapes may be connected for example by straight portions or instead by other, for example slightly arched curve portions. The oval shape of the internal contour 81 could alternatively be substantially an elliptical or ellipse-like shape.

The housing 80 has the motor-part-side fluid inlet 41, the motor-part-side fluid outlet 48, the pump-part-side fluid inlet 61 and the pump-part-side fluid outlet 68, which each produce a fluid-conducting connection to the interior region, defined by the internal contour 81, of the housing 80.

The rotor 85 of the example embodiment in FIG. 6 has a substantially circular cylindrical rotor main body 90 which, in FIG. 6, extends in the manner of a cylinder in a thickness direction perpendicular to the plane of the drawing and which is equipped in the illustrated example with radial slots in which radial displaceably mounted vanes 88 are arranged. The vanes 88 are preferably spring-loaded in an outward direction as viewed relative to the rotor main body 90 such that, during the rotation of the rotor 85 about the axis 86, the vanes 88 follow the internal contour 81 and lie against the latter, that is to say against a housing internal wall. In this way, cells 82a are formed at the motor side and cells 82b are formed at the pump side.

During the operation and thus during the rotation of the rotor 85, the motor-part-side air volume flow 74 comes into contact with the rotor 85 in a portion of the rotor which corresponds to a circumferential region 89a, which is fixed relative to the housing 80, of the rotor 85. By contrast, the pump-part-side air volume flow 76 comes into contact with the rotor 85 in a portion of the rotor which corresponds to a different circumferential region 89b, which differs from the circumferential region 89a and which is likewise fixed relative to the housing 80, of the rotor 85. It is however self-evident that, during continued rotation of the rotor 85, all of the vanes 88 alternately delimit cells 82a, which fill and empty again, on the motor side and cells 82b, which fill and empty again, on the pump side.

In FIG. 6, it is thus the case that a first part, which is an upper part in the diagrammatic illustration, of the housing 80, and that portion of the rotor 85 which is situated in the first part, are assigned to the motor part 34, whereas a second part, which is a lower part in the diagrammatic illustration, of the housing 80, and that portion of the rotor 85 which is situated in the second part, are assigned to the pump part 36. The first part also comprises the inlet 41 and the outlet 48, and the second part also comprises the inlet 61 and the outlet 68.

The axis of rotation 86 extends perpendicular to the plane of the drawing in FIG. 6. By the positioning of the axis of rotation 86 along a direction 87 which runs substantially along a direction of the greatest extent of the cross section of the internal contour 81 normal to the axis 86, the ratio of the volume flow corresponding to the motor-part-side fluid flow 74 to the volume flow corresponding to the pump-part-side fluid flow 76, and the pressure ratio in the motor and pump parts 34, 36, can be adjusted.

Here, in a first variant, the axis of rotation 86 may be positioned, and mounted relative to the housing 80, fixedly along the direction 87 in order to fix the volume flow ratios. In this first variant of the pressure intensifier 28, the rotor axis of rotation 86 is therefore not displaceable. In a second variant of the pressure intensifier 28 of FIG. 6, the rotor 85 may be mounted relative to the housing 80 such that the position of the axis of rotation 86 can be adjusted relative to the housing 80 along the direction 87. In this way, the pressure intensifier 28 can be adapted for different tasks, for example for boosting a negative pressure for the operation of the waste-compacting device 3 or of some other device.

In other words, in this second variant, it is thus possible for the pressure ratio and the ratio of the volume flows between motor side and pump side to be varied through variation of the eccentricity of the rotor 85 by displacement of the rotor axis of rotation 86 along the direction denoted by the reference designation 87 in FIG. 6.

With the pressure intensifier 28 as per the example embodiment in FIG. 6, it is thus possible for the functions of the pump part 36 and of the motor part 34 to be realized utilizing the common rotor 85 with vanes or slides 88 mounted displaceably in the rotor main body 90. It is consequently possible to avoid the use of two separate rotors, whereby a space requirement and a variety of components are further reduced. Thus, in FIG. 6, both sides of a rotor 85 that is common to the motor and pump parts 34, 36 are utilized. The pressure intensifier 28 is also driveable by a pressure difference between the interior air pressure of the pressurized cabin 2 and the external air pressure in the surroundings of the airplane 1.

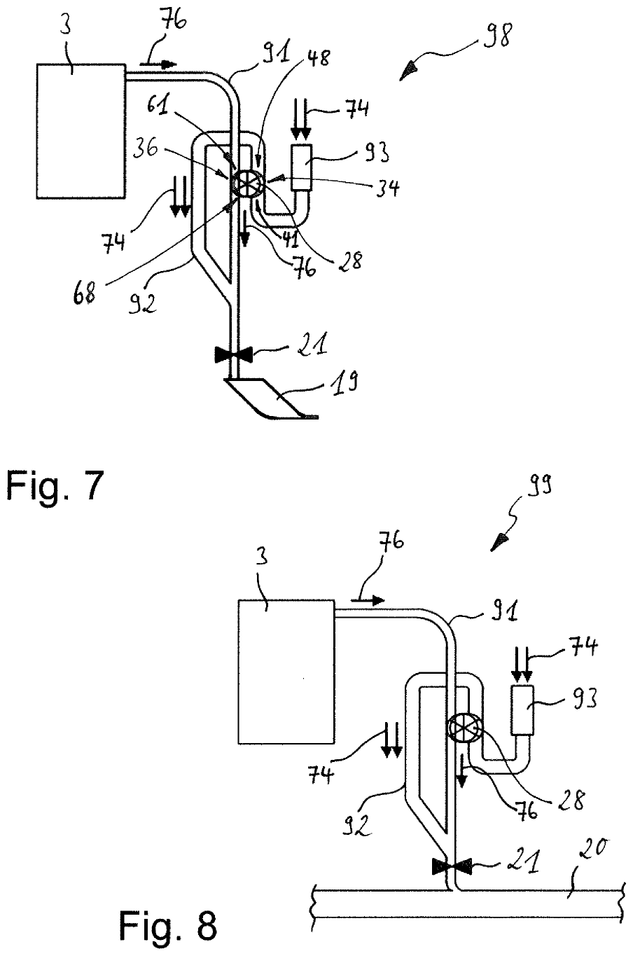

FIG. 7 shows an arrangement 98 in the airplane 1. Here, the pressure intensifier 28 of FIG. 6 is shown as a vacuum booster in an installed state in the airplane 1, wherein the pressure intensifier 128 may alternatively be used instead of the pressure intensifier 28. The statements below are applicable analogously with regard to the use of the pressure intensifier 128.

A first line path 91 permits coupling of the waste-compacting device 3 in fluid-conducting fashion to the drain mast 19 as negative-pressure source. The first line path 91 leads via the pump part 36 of the pressure intensifier 28 which acts as vacuum booster and by which the acting negative pressure is boosted. Here, therefore, the pump-part-side fluid inlet 61 is coupled to the waste-compacting device 3, whereas the pump-part-side fluid outlet 68 is couplable to the drain mast 19.

The fluid flow 76 which is extracted from the waste-compacting device 3, and which in the example embodiment shown is an air flow, is discharged, downstream of the vacuum booster 28, via the drain mast 19, wherein, upstream of the drain mast 19, there is provided a valve 21 which permits regulation for example in a manner dependent on the compaction requirement.

A second line path 92 is led from an interior space of the pressurized cabin 2 via the motor part 34 of the pressure intensifier 28, such that the motor-part-side fluid inlet 41 is coupled to the interior space of the pressurized cabin 2 and the motor-part-side fluid outlet 48 is couplable to the drain mast 19.

It is thus possible, via the motor part 34 of the pressure intensifier 28, for a fluid flow 74, again an air flow, corresponding to a first volume flow to be discharged from the interior space of the pressurized cabin 2 via a silencer 93 (“muffler”) to the external surroundings, and to be conducted via the motor part 34 of the pressure intensifier 28 in the process. A second volume flow, corresponding to the fluid flow 76, is smaller than the first volume flow. The first fluid flow 74 drives the pressure intensifier 28.

In this way, the pressure intensifier 28 boosts the negative pressure prevailing at the waste-compacting device 3, whereby the latter can be reliably operated even at low altitudes. In FIG. 7, the fluid flows 76, 74 conducted via the pump part 36 and the motor part 34 are merged downstream of the pressure intensifier 28 and are discharged via the drain mast 19 in a manner which can be regulated by the valve 21. Here, the valve 21 is arranged downstream of the merging point of the fluid flows 74, 76.

The arrangement 99 illustrated in FIG. 8 corresponds to that of FIG. 7, with the exception of the negative-pressure source. In FIG. 8, a main line 20 of a vacuum toilet system is utilized as negative-pressure source. In the variant of FIG. 8, too, the pressure intensifier 128 of FIG. 5 may be used analogously instead of the pressure intensifier 28 of FIG. 6.

In each of the two example embodiments of FIGS. 7 and 8, substantially the air pressure difference between the interior space of the pressurized cabin 2 and the external surroundings of the airplane 1 is utilized as an input pressure difference for the operation of the pressure intensifier 28 or 128 respectively and of the device 3. At the pump part side, a driving pressure difference which is greater than the motor-part-side input pressure difference is provided by the pressure intensifier 28 or 128.

The pressure intensifier 28, 128 which operates as vacuum booster has only a small space requirement for the accommodation thereof, and can furthermore be of weight-saving design. For use in the aerospace sector, for example in the airplane 1, the small structural size and the low weight of the pressure intensifier 28, 128 and in particular the particularly compact structural form of the pressure intensifier 28 are advantageous.

The pressure intensifier 28, 128 is furthermore of simple construction. No control unit is required in order to realize continuous operation. Such a simple construction is advantageous with regard to the desired reliability of the pressure intensifier 28, 128 and of a system within which the pressure intensifier is used.

Furthermore, the pressure intensifier 28, 128 operates with a low level of vibration, which is advantageous specifically if it is used in an aircraft or spacecraft, for example the airplane 1. An impairment of the comfort of passengers and crew owing to vibrations and/or generation of noise can be avoided.

For a waste-compacting device 3, it may for example prove expedient if a volume flow of approximately 60 litres/min can be extracted from the interior space 8. A vacuum booster 28 for use together with the waste-compacting device 3, such as for example in the arrangements 98 or 99 of FIG. 7 or 8 respectively, which vacuum booster can provide such a volume flow, could be designed for example with a diameter of approximately 100 mm and a depth of approximately 60 mm, wherein a rotational speed of approximately 20 revolutions per second is conceivable by way of example for the rotor 85.

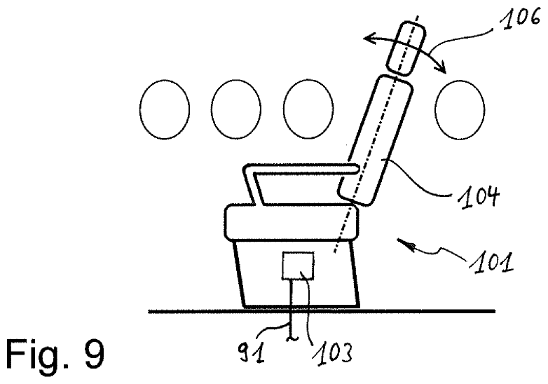

FIG. 9 shows, in schematically simplified form, a further example embodiment, in the case of which an adjusting device 103 for a backrest 104 of a seat arrangement 101 is driven by a pressure difference boosted by a vacuum booster 28 or 128. Thus, utilizing the input pressure difference, that is to say the difference between cabin pressure and external ambient pressure, the device 103 can also be driven with the aid of a driving pressure difference, which is greater than the input pressure difference, through the use of the proposed vacuum booster 28 or 128.

The example embodiment of FIG. 9 therefore differs from the example embodiments described above in that, now, instead of the waste-compacting device 3, the adjusting device 103 is driven in order, for example, to enable an aircraft passenger to comfortably adjust 106 the backrest inclination. The further statements relating to the preceding example embodiments are also analogously applicable to the example of FIG. 9, wherein the numerical values stated by way of example further above for volume flows, rotational speeds and geometrical dimensions of the vacuum booster may however differ as required. The adjusting device 103 may in this case be arranged, and coupled in fluid-conducting fashion to the negative-pressure source, to the vacuum booster 28, 128 and to the interior space of the pressurized cabin 2, analogously to the device 3 as illustrated in FIG. 7 or FIG. 8.

In all of the example embodiments discussed above, it is possible in particular for the housings 80, 180a, 180b, the rotors 85, 185a, 185b with the rotor main bodies 90, 190a, 190b, and the vanes 88, 188a, 188b to each be formed with a plastics material or to be manufactured substantially from a plastics material. The pressure intensifier 28, 128 is thus of particularly weight-saving form. Components which slide on one another, for example the vanes 88 or 188a, b and the housing 80 or 180a, b, or the vanes 88 or 188a, b and the rotor main body 90, 190a, b, are preferably manufactured with plastics materials such that the material pairing of the elements that slide on one another leads to the least possible friction and the least possible wear.

Although the disclosure herein has been described above entirely on the basis of a preferred example embodiment, the disclosure herein is not restricted to this but may rather be modified in a variety of ways.

For example, the proposed pressure intensifier may also be used in an expedient and beneficial manner for other applications in which, for example, a boosted negative pressure is required, for example in the extraction of gaseous fluids in a manufacturing process.

While at least one example embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the example embodiment(s). In addition, in this disclosure, the terms “comprise” or “comprising” do not exclude other elements or steps, the terms “a”, “an” or “one” do not exclude a plural number, and the term “or” means either or both. Furthermore, characteristics or steps which have been described may also be used in combination with other characteristics or steps and in any order unless the disclosure or context suggests other-wise. This disclosure hereby incorporates by reference the complete disclosure of any patent or application from which it claims benefit or priority.

### LIST OF REFERENCE DESIGNATIONS

1 Airplane
2 Pressurized cabin
3 Waste-compacting device
4 Waste items
6 Trolley
8 Interior space (trolley)
10 Corrugated bellows
11 Compacting plate
12 Top side
15 Line
16 Acting cabin interior pressure
19 Drain mast
20 Main line (vacuum toilet system)
21 Valve
24 Volume flow
28, 128 Pressure intensifier
34, 134 Motor part
36, 136 Pump part
41, 141 Motor-part-side fluid inlet
48, 148 Motor-part-side fluid outlet
150 Shaft
61, 161 Pump-part-side fluid inlet
68, 168 Pump-part-side fluid outlet
74, 174 Motor-part-side fluid flow
76, 176 Pump-part-side fluid flow
80 Housing
180a,b Housing
81 Internal contour
181a, b Internal contour
82a,b Cell
182a,b Cell
85 Rotor
185a,b Rotor
86 Axis of rotation (rotor 85)
186 Axis of rotation (rotors 185a, 185b)
87 Direction
88 Vane
188a,b Vane
89a,b Circumferential region (rotor)
90 Rotor main body
190a,b Rotor main body
91 First line path
92 Second line path
93 Silencer
98, 99 Arrangement
101 Seat arrangement
103 Adjusting device
104 Backrest
106 Adjusting movement

1. A pressure intensifier designed as a vacuum booster, comprising:
a motor part with a motor-part-side fluid inlet and a motor-part-side fluid outlet and a pump part with a pump-part-side fluid inlet and a pump-part-side fluid outlet;
wherein the pressure intensifier is driveable by a motor-part-side fluid flow from the motor-part-side fluid inlet to the motor-part-side fluid outlet for conveying a pump-part-side fluid flow from the pump-part-side fluid inlet to the pump-part-side fluid outlet; and
wherein the pressure intensifier is a positive-displacement machine with at least one rotatable rotor.

2. The pressure intensifier according to claim 1, wherein the motor part and the pump part are designed such that a first volume flow corresponding to the motor-part-side fluid flow is greater than a second volume flow corresponding to the pump-part-side fluid flow.

3. The pressure intensifier according to claim 1, wherein the at least one rotor has displaceably arranged vanes, and wherein the motor part is operable in a manner of a vane-type motor and the pump part is operable in a manner of a vane-type pump.

4. The pressure intensifier according to claim 1, wherein the rotor of the pressure intensifier is a rotor common to the motor part and the pump part and configured, during operation, to come into contact in certain portions with the motor-part-side fluid flow and the pump-part-side fluid flow.

5. The pressure intensifier according to claim 1, wherein the motor part and the pump part together form a structural unit and comprising a housing which is common to the motor part and the pump part, wherein the housing has the motor-part-side fluid inlet, the motor-part-side fluid outlet, the pump-part-side fluid inlet and the pump-part-side fluid outlet, such that the motor-part-side fluid inlet, the motor-part-side fluid outlet, the pump-part-side fluid inlet and the pump-part-side fluid outlet each have a fluid-conducting connection to an internal region defined by an internal contour of the housing.

6. The pressure intensifier according to claim 5, wherein a position of an axis of rotation of the rotor relative to the housing is adjustable.

7. The pressure intensifier according to claim 1, wherein the pressure intensifier is configured for being driven by a pressure difference between interior pressure in a pressurized cabin of an aircraft or spacecraft and external pressure in external surroundings of the aircraft or spacecraft.

8. An arrangement in an aircraft or spacecraft, comprising a device which is driveable by a driving pressure difference, and comprising a vacuum booster for providing the driving pressure difference utilizing an input pressure difference which is smaller than the provided driving pressure difference.

9. The arrangement according to claim 8, wherein the vacuum booster is a rotating positive-displacement machine, in particular as a pressure intensifier designed as a vacuum booster, the pressure intensifier comprising:
a motor part with a motor-part-side fluid inlet and a motor-part-side fluid outlet and a pump part with a pump-part-side fluid inlet and a pump-part-side fluid outlet;
wherein the pressure intensifier is driveable by a motor-part-side fluid flow from the motor-part-side fluid inlet to the motor-part-side fluid outlet for conveying a pump-part-side fluid flow from the pump-part-side fluid inlet to the pump-part-side fluid outlet; and
wherein the pressure intensifier is a positive-displacement machine with at least one rotatable rotor.

10. The arrangement according to claim 8, wherein the device is couplable in fluid-conducting fashion via a first line path to a negative-pressure source, an interior space of a pressurized cabin of the aircraft or spacecraft is couplable in fluid-conducting fashion to the negative-pressure source via a second line path, and the vacuum booster is arranged such that the first line path leads via a pump part of the vacuum booster and the second line path leads via a motor part of the vacuum booster.

11. The arrangement according to claim 8, wherein the first and second line path can be placed in fluidic connection with a drain mast of a wastewater system of the aircraft or spacecraft or with a line of a vacuum toilet system of the aircraft or spacecraft as negative-pressure source.

12. The arrangement according to claim 8, wherein the device is a waste-compacting device.

13. The arrangement according to claim 8, wherein the device is an adjusting device for a component of a seat arrangement.

14. An aircraft or spacecraft having a pressure intensifier according to claim 1.

15. An aircraft or spacecraft having an arrangement according to claim 8.

16. A method for operating a device in an aircraft or spacecraft, comprising:
discharging a first fluid flow as air volume flow from an interior space of a pressurized cabin of the aircraft or spacecraft via a motor part of a vacuum booster in a direction of external surroundings of the aircraft or spacecraft;
driving the vacuum booster by the first fluid flow and, by the vacuum booster driven in this way, providing a second fluid flow as air volume flow at a pump part of the vacuum booster, wherein the second fluid flow is discharged in the direction of the external surroundings of the aircraft or spacecraft; and
operating the device by the discharge of the second fluid flow.
